(19) United States
(12) Patent Application Publication
(10) Pub. No.: US 2026/0153127 A1
(43) Pub. Date: Jun. 4, 2026

(54) ARRANGEMENT OF A WHEEL HUB CONNECTED TO A CONSTANT VELOCITY JOINT AND WITH A LOW-FRICTION SEALING DEVICE

(71) Applicant: AKTIEBOLAGET SKF, GOTEBORG (SE)

(72) Inventors: Riccardo NARDICCHIA, Torino (IT); Ivan MAURO, Bricherasio (IT)

(21) Appl. No.: 19/400,217

(22) Filed: Nov. 25, 2025

(30) Foreign Application Priority Data
Dec. 3, 2024 (IT) 102024000027390

(51) Int. Cl. F16C 33/78; F16C 33/80

(52) U.S. Cl. CPC F16C 33/7823; F16C 33/7876; F16C 33/805

(57) ABSTRACT

An assembly includes a wheel hub and a sealing device forming a first seal between inner and outer rings of a bearing of the wheel hub and a second seal with a constant velocity joint connected to a first end of the inner ring of the bearing. The sealing device includes a sleeve mounted on a cylindrical outer surface of the inner ring that has a first annular radially outwardly extending flange on a first end and a second end that projects beyond an end of the wheel to surround and form a seal with the constant velocity joint. The flange is spaced from an annular wall of the inner ring and from a second flange that extends radially inward from the outer ring. The second flange includes a seal lip that extends toward the first flange and axially outward of the annular wall of the inner ring.

### CROSS-REFERENCE

This application claims priority to Italian patent application no. 102024000027390 filed on Dec. 3, 2024, the contents of which are fully incorporated herein by reference.

### TECHNOLOGICAL FIELD

The present disclosure relates to a sealing device for wheel hub units connected to constant velocity joints and to the respective arrangement thereof, having good sealing action combined with low operating friction and a simplified structure, and also easy and rapid assembly.

In particular, the disclosure relates to an arrangement in which a wheel hub unit configured to support a vehicle drive wheel is angularly secured to an associated constant velocity joint for the transmission of drive torque from the shaft of the axle to the wheel and is provided with a sealing device arranged to protect both rolling bodies interposed between an inner ring and an outer ring of the wheel hub unit, and an angular mechanical coupling between the wheel hub unit and the constant velocity joint. The inner and outer rings are made relatively rotatable by the rolling bodies about a common axis of symmetry of the inner and outer rings and of the wheel hub unit as a whole.

### BACKGROUND

It is known that the transmission of drive torque from a constant velocity joint to a wheel hub unit is made possible by meshed teeth (or related means) that are present on the adjacent and opposite ends of the wheel hub and of the outer ring of the constant velocity joint. The teeth of other means can be constituted by a conventional splined coupling, or by a pair of frontal teeth which engage head to head, as disclosed in WO 2009/140996, in EP 2042755, or even in EP 2043880 (also published as WO 2008/006339).

In particular, in the case of frontal teeth, the joining region between the wheel hub and the constant velocity joint has to be protected from infiltrations of external contaminants (water, dust, mud, dirt); the same is true for the rolling bodies mounted between the inner ring and the outer ring, which is provided with means for fastening the suspension to the pillar that are generally constituted by a radially outer flange formed in one piece with the outer ring.

According to EP 2043880, such protection is provided by a single sealing device having two opposing shields, namely, a first annular shield fastened in axial abutment against the inner ring, on the side facing towards the constant velocity joint, and a second shield fastened to the outer ring and carrying a sealing ring equipped with one or more sliding lips which contactingly cooperate with the first annular shield. The first annular shield presents an axial “leg”, or sleeve portion, produced by means of a double fold and which extends so that a free end thereof protrudes from the inner ring of the bearing formed by the wheel hub and towards the outer ring of the constant velocity joint, in order to cover the area of the joint. This protruding part can be equipped with an annular seal which cooperates radially with an abutment of the outer ring of the constant velocity joint; furthermore, the protruding part, or the face of a flanged part, or “radial leg” of the first annular shield, facing in use towards the constant velocity joint can be equipped with an annular signal generating element (also called “trigger wheel”) formed, if the shield is made of ferromagnetic metal material, by alternate inserts and depressions, or by an annular portion of a seal made of magnetizable elastomeric or plastics material, which is magnetized in such a way as to have alternate magnetized and non-magnetized areas, or areas with opposing polarities. Once in use coupled to a suitable sensor, the “trigger wheel” which, on the basis of what has been stated, is secured to the inner ring of the bearing, generates a signal which is generally used to detect the rotational speed of the wheel of the vehicle.

The solution according to EP 2043880 leaves a limited space available for the sensor operatively associated with the “trigger wheel”, is relatively difficult to mount and relatively large and, in particular, due to a double axial abutment, can be subject to deformation loads during use which, when present, can cause undesired and uncontrolled deformations.

Such drawbacks are addressed by the wheel hub arrangement connected to a constant velocity joint and equipped with a sealing device according to EP 2815892 from the same applicant. This solution, even though relatively simple and rapid to mount, economical, and leaving a lot of space for the speed sensor and the signal generating element associated therewith, so as to ensure a strong and reliable electrical signal, has the drawback of having, in certain arrangements requiring the presence of one or more axial sliding sealing lips, relatively high friction, due to the fact that the axial sliding sealing lips have to be arranged in a radial position relatively distant from a radially outer lateral surface of the inner ring due to the type of coupling necessary between the sealing device and the inner ring.

### SUMMARY

The present disclosure provides a wheel hub arrangement connected to a constant velocity joint and equipped with an improved sealing device that can be used in a vehicle drive wheel, which does not have any of the drawbacks described above.

The disclosure provides a wheel hub arrangement that is connected to a constant velocity joint, equipped with a sealing device and capable of simultaneously ensuring, in use, low friction, optimal hydraulic sealing with respect to external contaminants, reduced size and plenty of space available for the installation of a speed sensor and of the signal generating element associated therewith.

According to the present disclosure, a wheel hub arrangement that is connected to a constant velocity joint, equipped with a sealing device and has the features set out in the attached claims is provided.

An embodiment of the disclosure comprises a wheel hub and a sealing device. The wheel hub includes an inner ring and an outer ring and a plurality of rolling elements between the inner ring and the outer ring, the inner ring having a first end facing in a first direction and being configured to connect to a constant velocity joint. The sealing device is formed from a first annular shield and a second annular shield. The inner ring has a cylindrical outer surface, an annular wall extending radially inward from the cylindrical outer surface and facing in the first direction, and a cylindrical mounting surface extending away from the annular wall in the first direction. The first annular shield includes aa first cylindrical sleeve having a first end surrounding the inner ring, a first annular flange extending radially outward from the first end of the first cylindrical sleeve at a predetermined distance from the annular wall of the inner ring, and a first end portion extending in the first direction from the first end of the cylindrical sleeve, the first end portion being press-fit on the cylindrical mounting surface. The first annular shield also includes aa second end portion extending beyond the first end of the inner ring, and a second end configured to sealingly engage against the constant velocity joint. The second annular shield includes a second cylindrical sleeve mounted to an inner surface of the outer ring, the second cylindrical sleeve having a first end and a second end spaced from the first end in a second direction opposite the first direction, and a second annular flange extending radially inward from the second end of the second cylindrical sleeve. A first side of the first annular flange faces in the first direction and a second side of the first annular flange faces in the second direction and a first side of the second annular shield faces in the first direction and a second side of the second annular flange faces in the second direction. At least a portion of the second annular flange is substantially parallel to the first annular flange, the first side of the second annular flange faces the second side of the first annular flange, and a signal generating element is mounted to the first side of the first annular flange and faces in the first direction. The second annular flange includes an elastomeric sealing element having a first annular axial sealing lip on the first side of the second annular flange, the first annular axial sealing lip having a free end in sliding contact with the second side of the first annular flange. The elastomeric sealing element also has a second annular axial sealing lip radially outside the first annular axial sealing lip that has a free end spaced from the second side of the first annular flange. The second flange is located to a first axial side of the annular wall of the inner ring and the free ends of the first and second annular axial sealing lips are located to a second axial side of the annular wall of the inner ring.

### BRIEF DESCRIPTION OF THE DRAWINGS

The disclosure is described below with reference to the attached drawings, which show two non-limiting example embodiments thereof, in which:

FIG. 1 is a sectional side elevational view of a wheel hub arrangement that is connected to a constant velocity joint and equipped with a sealing device and produced according to the disclosure,

FIG. 2 is a detail view of the upper portion of FIG. 1.

FIG. 3 is a detail view of a portion of FIG. 2.

FIG. 4 schematically shows, on a further enlarged scale with respect to FIG. 2, the same constructional detail of FIG. 3, showing a second embodiment of the disclosure.

### DETAILED DESCRIPTION

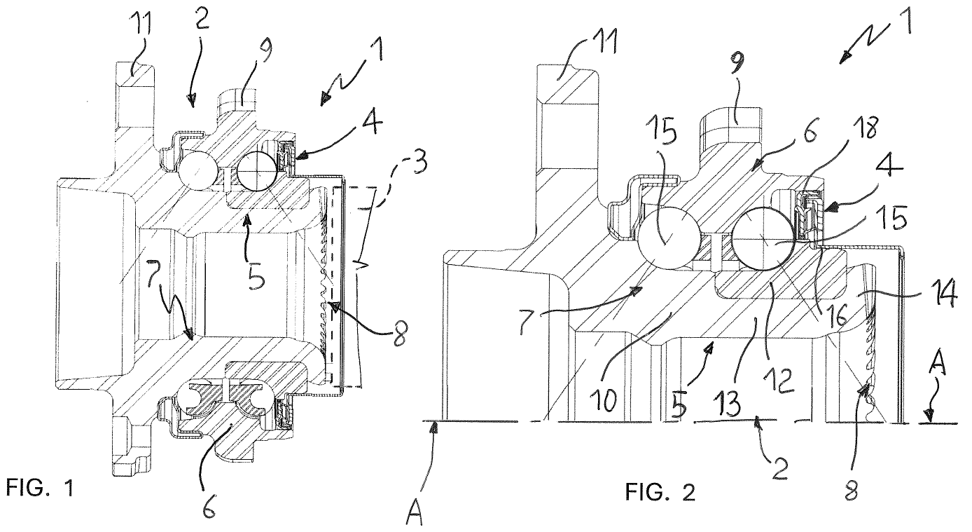

With reference to FIGS. 1 to 3, reference sign 1 denotes a complete transmission arrangement or unit formed by a wheel hub 2 connected to a constant velocity joint 3 and equipped with a sealing device 4 interposed in use between an inner ring 5 and an outer ring 6 of a rolling bearing 7 forming part of, or constituting, the wheel hub 2.

The constant velocity joint 3, which is itself known, is shown only schematically with a block and a dashed line. As will be seen, the sealing device 4 extends such that it straddles the wheel hub 2 and the constant velocity joint 3 to protect a frontal toothed coupling 8 for torque transmission, of which only the portion formed angularly secured to the inner ring 5 is shown for simplicity.

In the non-limiting example shown, the rolling bearing 7 alone constitutes the entire wheel hub 2, since the outer ring 6 is provided with a radial flange 9 for the mounting on a vehicle suspension pillar, which are known and not shown for simplicity, and the inner ring 5 (FIG. 2) is composed of a spindle-shaped tubular element 10 provided with a known radial flange 11 which is configured to receive in use a vehicle wheel, and of a small inner ring 12, known under the acronym SIR, which is fitted angularly securely on a cylindrical end 13 (FIG. 2) of the tubular element 10, on which it is locked by means of an upturned portion or edge 14 of the end 13, which is also provided with the frontal toothed coupling 8. Interposed between the rings 5 and 6 are two rows of rolling bodies 15, constituted by balls in the non-limiting example shown, which make the rings 5 and 6 relatively rotatable about a common axis of symmetry A, which is also the axis of symmetry of the wheel hub 2 and of the constant velocity joint 3.

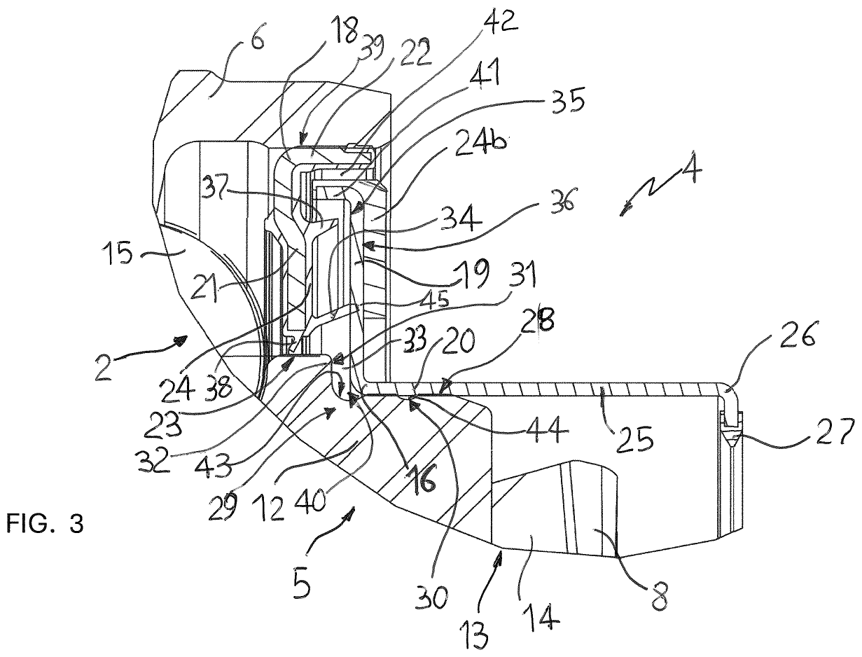

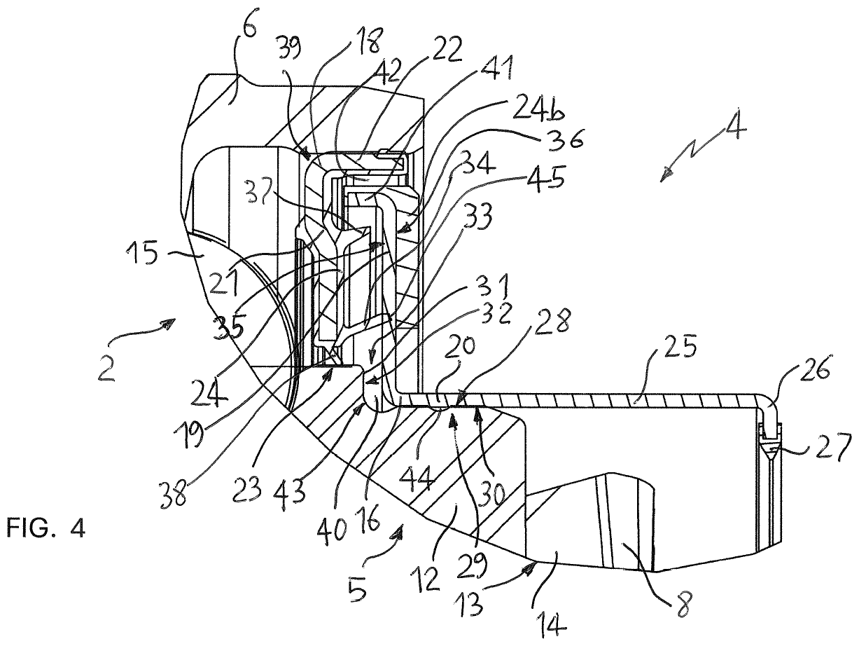

With reference also to FIGS. 3 and 4, where details that are similar or identical in both are denoted by the same reference numbers, the sealing device 4 comprises a first annular shield 16 carried securely by the inner ring 5 and a second annular shield 18 carried securely by the outer ring 6. In the present disclosure first annular shield 16 is carried angularly securely by the small inner ring 12, radially on the outside thereof.

The first annular shield 16 is preferably produced as a punched and bent metal sheet and comprises a flange portion 19 (first flange) which projects radially outwardly from a sleeve portion 20 (first cylindrical sleeve) with which the first annular shield 16 is fitted angularly securely to the inner ring 5 as a whole (tubular element 10 and small inner ring 12), radially on the outside thereof, in this case of a radially outer lateral surface 23 (cylindrical outer surface) of the inner ring 5 belonging to the small inner ring 12 in the example shown.

The second annular shield 18 is also preferably produced as a punched and bent metal sheet and also comprises a flange portion 21 (second annular flange) which projects radially inwardly from a sleeve portion 22 (second cylindrical sleeve) with which the second annular shield 18 is fitted angularly securely to a radially inner portion of the outer ring 6.

The flange portions 19 and 21 of the first annular shield 16 and of the second annular shield 18, respectively, are arranged at least partially facing each other, and the flange portion 21 of the second annular shield 18 includes an annular elastomeric sealing element 24 having a plurality of annular sealing lips, which will be described in detail below.

The flange portion 19 of the first annular shield 16 is furthermore provided, towards the constant velocity joint 3, with a signal generating element 24b, which is itself known, in the example shown constituted by an annular seal insert produced from a magnetizable synthetic elastomeric or plastic material (for example with the addition of a magnetizable powder), which is magnetized in such a way as to have alternate magnetized and non-magnetized circumferential areas, or alternate circumferential areas of opposing polarities.

The flange portion 19 presents radially on the inside a simple L-shaped fold which will form the sleeve portion 20 of the first annular shield 16, configured for coupling with the inner ring 5.

The sleeve portion 20 projects axially directly from the flange portion 19, on the side of the signal generating element 24b, and presents an axial extension such that it protrudes axially from the inner ring 5 towards the constant velocity joint 3 so as to form a tubular element 25 which projects away from the inner ring 5 and is arranged in use straddling the wheel hub 2 and the constant velocity joint 3 and the junction therebetween. The tubular element 25 is configured to cooperate in use in a fluid-tight manner with the constant velocity joint 3 and, for this purpose, a free axial end 26 thereof is provided with an annular static seal 27 produced from an elastomeric material like the annular sealing element 24.

According to a first aspect of the disclosure, the sealing device 4 further comprises a first end section 29 of the radially outer lateral surface 23 of the inner ring 5 on which is formed on the side facing the constant velocity joint 3 an annular step 28 (cylindrical mounting surface) bounded by an annular bottom wall 30 and by an annular frontal end wall 31 forming on the inner ring 5 an axial shoulder 32 facing the same direction as the signal generating element 24b and arranged radially flush with the radially outer lateral surface 23 of the inner ring 5.

The sleeve portion 20 of the first annular shield 16 is form-fittingly mounted on the annular bottom wall 30 of the annular step 28, so that the flange portion 19 of the first annular shield 16 is arranged adjacent to, but axially spaced apart from, the annular frontal end wall 31 of the annular step 28 and forms a predetermined axial gap 33 therewith.

According to one aspect of the disclosure, and in combination with that which has already been described, the annular elastomeric sealing element 24 comprises a first annular axial sealing lip 34 coupled in sliding contact and with an axial interference fit with a first face 35 of the flange portion 19 of the first annular shield 16 facing away from a second face 36 of the flange portion 19 of the first annular shield 16 that directly supports the signal generating element 24b without the interposition of other elements or of folds in the flange portion 19.

The annular elastomeric sealing element 24 further comprises at least one second annular axial sealing lip 37 cooperating in a non-contacting manner with the first face 35 of the flange portion 19 of the first annular shield 16 in a position radially outside the first annular lip 34. The first annular lip 34 and the at least one second annular axial sealing lip 37 extend straddling the axial gap 33, radially on the outside thereof. In possible embodiments that are not shown for simplicity, the elastomeric sealing element 24 may comprise a plurality of non-contacting axial sealing lips 37, i.e. configured to produce a labyrinth seal with the face 35, arranged radially in series between the sleeve portion 22 and the contacting axial sealing lip 34.

The annular elastomeric sealing element 24 further comprises a third annular sealing lip 38, radially oriented and configured to cooperate with a second section of the radially outer lateral surface 23 of the inner ring 5, immediately adjacent to the first section 29 provided with the step 28. The third annular sealing lip 38 is arranged immediately adjacent to the first annular sealing lip 34.

The first annular sealing lip 34 and the third annular sealing lip 38 project from the same radially inner edge of the flange portion 21 of the second shield 18.

The flange portion 21 then, in particular, projects radially from an end 39 of the sleeve portion 22 of the second shield 18 facing away from the first annular shield 16 and radially on the inside of the sleeve portion 22 of the second shield 18 with which it forms a simple L-shaped fold.

In the embodiment in FIG. 3, the first and third annular lips 34 and 38 are arranged obliquely to each other so as to form in radial section an obtuse angle, and the third annular lip 38 forms with the mentioned second section of the radially outer lateral surface 23 of the inner ring 5 a non-contacting labyrinth seal.

In the embodiment of FIG. 4 as well, the first annular sealing lip 34 and the third annular sealing lip 38 project from the same radially inner edge of the flange portion 21 of the second shield 18, but the first and third annular lips 34 and 38 are arranged obliquely to each other so as to form in radial section an acute angle. In this embodiment, furthermore, the third annular lip 38 may be configured so as to form with the second section of the radially outer lateral surface 23 of the inner ring 5 a sliding contacting seal or non-contacting labyrinth seal.

In both of the two embodiments shown, the first lip 34 and the third lip 38 form with each other and with the first face 35 of the flange portion 19 of the first annular shield 16 and with the second section of the radially outer lateral surface 23 of the inner ring 5 a collecting chamber 40 for any external contaminants reaching the axial gap 33.

In the two embodiments shown, the first annular shield 16 further comprises a second sleeve portion 41 projecting axially from a radially outer end of the flange portion 19, on the side opposite to the first sleeve portion 20 and radially on the inside of the sleeve portion 22 of the second shield 18, which it faces and from which it is separated by a predetermined radial gap 42 configured to form with the first annular shield 16 a labyrinth pre-seal.

In alternative embodiments that are not shown for simplicity, this second sleeve portion 41 may be absent and the labyrinth pre-seal may be effected by the radially outer edge of the flange portion 19 which flanks the sleeve portion 22 of the shield 18 radially on the inside.

In all the embodiments, in fact, the flange portion 19 of the first annular shield 16 is preferably arranged axially within the second shield 18; specifically, arranged radially within the sleeve portion 22 of the second shield 18.

According to both of the embodiments in FIGS. 3 and 4, the annular bottom wall 30 of the annular step 28 formed on the radially outer surface 23 of the inner ring 5 is provided with a first annular groove 43 bounded by a concave curved bottom wall and arranged immediately adjacent to the annular frontal end wall 31 of the annular step 28 forming on the inner ring the axial shoulder 32.

The annular groove 43 faces the annular sealing lip 34 and bounds radially on the inside the axial gap 33 and thus also the collecting chamber 40 for the contaminants, providing the chamber with a concave shape which improves the functioning thereof.

According to a preferred embodiment, the annular bottom wall 30 of the annular step 28 is directly formed by grinding on the radially outer surface 23 of the inner ring 5 and is also provided with a second annular groove 44 formed in a position distal from the annular frontal end wall 31 of the annular step 28, on the ground section of the annular bottom wall 30 of the annular step 28 form-fittingly engaged with the first sleeve portion 20 of the first annular shield 16, so as to be arranged radially within the first sleeve portion 20 of the first annular shield 16 which, in practice, externally covers the annular groove 44. The presence and position of the annular groove 44 facilitate the form-fitting retention of the shield 16 on the inner ring 5 in a correct and stable axial position.

Lastly, the L-shaped fold of the flange portion 19 of the first annular shield 16 which will form the first sleeve portion 20 is configured with a pre-folding angle suitable to ensure, when the form-fitting coupling is completed, an accurate perpendicularity tolerance between the signal generating element 24b and an end surface 45 of the first annular axial sealing lip 34 with respect to the axis of rotation A of the rolling bearing 7. In practice, the protruding tubular element 25 formed by the protruding continuation of the sleeve portion 20 is formed with a slight predetermined conicity which, when slightly deformed elastically due to the form-fitting coupling with the bottom wall 30 of the annular step 28, makes it possible to obtain perfect perpendicularity of the flange portion 19 with respect to the axis A, compensating for the slight deformations that inevitably form during mounting.

It is clear from the foregoing that the hydraulic seal obtainable from the low-friction sealing device 4 with improved sealing performance due to a combination of pre-labyrinths (gap 42 and lip or lips 37), contact lips 34 and, preferably, 38 and an internal trap for contaminants that is constituted by the collecting chamber 40.

The reduction of the friction is obtained via the accurate positioning of the shield 16 and by the fact that the contact lips, such as the axial contact lip 34, are positioned on reduced diameters, i.e. closer to the axis A than in the prior art, which is made possible by the simplified shape of the shield 16 and of the annular step 28, making it possible to reduce the radial size of these components, thus leaving more space for the sealing lips and for the signal generating element 24b.

The overall assembly is simplified and the construction of the arrangement 1 is more economical.

In this way, features for simultaneously improving both the signal obtainable from the generating element 24b (the radially wider it is the better) and the retention of the static seal 27 are implemented.

Consequently, the following advantages are obtained:

Simplified construction and lower costs: the signaling element or encoder 24b and the static seal 27 are integrated in one piece with the metal shield 16 with a reduced number of folds, in practice only one. The encoder 24b and the static seal 27 may be co-molded together directly on the shield 16 using two different rubber compounds, molded on the same metal support. The compound of the static seal 27 may be produced from NBR (butadiene-acrylonitrile copolymer), and the encoder 24b may be produced from NBR loaded with ferrite.

Reduced friction: the axial/radial lips 34, 38 are positioned at the smallest possible diameter.

Accurate positioning of encoder 24b and seal 27: advantage in terms of friction, sealability and magnetic signal (flux density and low error rates).

Improved sealability by means of pre-labyrinths 42, 37 and an internal collecting chamber 40 as trap for contaminants.

Simplified assembly procedure, it being direct rather than in successive steps as is currently necessary for sealing devices composed of several elements assembled together.

Improved retention (and greater extraction force) of the sealing device 4 as a whole on/from the form-fitting surface (bottom wall 30) resulting in stable axial positioning of the contacting seals 34 and 27, and of the encoder 24b.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved wheel hub sealing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. An assembly comprising:
a wheel hub including an inner ring and an outer ring and a plurality of rolling elements between the inner ring and the outer ring, the inner ring having a first end facing in a first direction and being configured to connect to a constant velocity joint, and
a sealing device comprising a first annular shield and a second annular shield,
wherein the inner ring comprises:
a cylindrical outer surface,
an annular wall extending radially inward from the cylindrical outer surface and facing in the first direction, and
a cylindrical mounting surface extending away from the annular wall in the first direction
wherein the first annular shield comprises:
a first cylindrical sleeve having a first end surrounding the inner ring,
a first annular flange extending radially outward from the first end of the first cylindrical sleeve at a predetermined distance from the annular wall of the inner ring,
a first end portion extending in the first direction from the first end of the cylindrical sleeve, the first end portion being press-fit on the cylindrical mounting surface,
a second end portion extending beyond the first end of the inner ring, and
a second end configured to sealingly engage against the constant velocity joint,
wherein the second annular shield comprises:
a second cylindrical sleeve mounted to an inner surface of the outer ring, the second cylindrical sleeve having a first end and a second end spaced from the first end in a second direction opposite the first direction, and
a second annular flange extending radially inward from the second end of the second cylindrical sleeve,
wherein a first side of the first annular flange faces in the first direction and a second side of the first annular flange faces in the second direction and a first side of the second annular shield faces in the first direction and a second side of the second annular flange faces in the second direction,
wherein at least a portion of the second annular flange is substantially parallel to the first annular flange,
wherein the first side of the second annular flange faces the second side of the first annular flange,
wherein a signal generating element is mounted to the first side of the first annular flange and faces in the first direction,
wherein the second annular flange includes an elastomeric sealing element having a first annular axial sealing lip on the first side of the second annular flange, the first annular axial sealing lip having a free end in sliding contact with the second side of the first annular flange,
wherein the elastomeric sealing element has a second annular axial sealing lip radially outside the first annular axial sealing lip and having a free end spaced from the second side of the first annular flange, and
wherein second flange is located on a first axial side of the annular wall of the inner ring and the free ends of the first and second annular axial sealing lips are located on a second axial side of the annular wall of the inner ring.

2. The assembly according to claim 1,
including the constant velocity joint,
wherein the second end of the first cylindrical sleeve holds a static seal element in contact with the constant velocity joint, and
wherein the second end portion of the first cylindrical sleeve spring biases the static seal element against the constant velocity joint.

3. The assembly according to claim 2,
wherein the elastomeric sealing element includes a third annular sealing lip extending radially toward the cylindrical outer surface of the inner ring and being located immediately adjacent to the first annular axial sealing lip.

4. The assembly according to claim 2,
wherein the first annular axial sealing lip and the third annular sealing lip are located at a radially inner end of the second annular flange and are arranged obliquely to each other so as to form in radial section an obtuse angle, and
wherein the third annular lip extends toward the cylindrical outer surface of the inner ring form a non-contacting labyrinth seal.

5. The assembly according to claim 2,
wherein the first annular axial sealing lip and the third annular sealing lip are located at a radially inner end of the second annular flange and are arranged obliquely to each other to form in radial section an obtuse angle, and
wherein the third annular lip extends to and contacts the cylindrical outer surface of the inner ring.

6. The assembly according to claim 2,
wherein the first annular axial sealing lip, the third annular lip, the second side of the first annular flange and the annular wall of the inner ring at least partially define a collecting chamber configured to receive external contaminants.

7. The assembly according to claim 2,
wherein a cylindrical projection extents from a radially outer end of the first annular flange in the second direction toward the second annular flange to form a labyrinth pre-seal.

8. The assembly according to claim 7,
wherein the first annular flange is entirely located axially between the second annular flange and the first end of the second cylindrical sleeve.

9. The assembly according to claim 2,
including a first annular groove at a junction of the cylindrical outer surface of the inner ring and the annular wall of the inner ring.

10. The assembly according to claim 9,
including a second annular groove in the cylindrical outer surface of the inner ring, the second annular groove being spaced from the first annular groove in the first direction.

11. The assembly according to claim 2,
wherein a surface of the signal generating element facing in the first direction is perpendicular to the cylindrical mounting surface of the inner ring.
